(19) United States
(12) Patent Application Publication
(10) Pub. No.: US 2010/0325709 A1
(43) Pub. Date: Dec. 23, 2010

(54) Method to store and distribute digital entertainment media data on a portable non-volatile solid-state storage device with a customer pre-selected security indentifier and content management system

(76) Inventor: Michael Lee Kawase, Oakville (CA)

Correspondence Address: MICHAEL LEE KAWASE, 20-2040 MARINE DRIVE, OAKVILLE, ON, L6L 1B4, CA

(21) Appl. No.: 12/655,476

(22) Filed: Dec. 31, 2009

Related U.S. Application Data
(63) Continuation-in-part of application No. 11/255,238, filed on Oct. 21, 2005, now abandoned.

(51) Int. Cl. H04N 7/173; H04N 7/12; G06F 15/16; G06F 21/20

(52) U.S. Cl. 726/7; 375/240.01; 725/115; 709/217; 375/E07.076

(57) ABSTRACT

A new method for storing and distributing Digital Entertainment Media Data like movies, (or indeed, other media content such as games, software, electronic books, audio books, documents, educational material and other formats of binary or source code), on a portable non-volatile solid-state storage device in a permanent or non-permanent state.

The data will be secured with the customers, media vendors/suppliers pre-selected or self-chosen security identifier and verification identification.

The data can be stored as a single data item or as a plurality of data files, such that a content management system is available to control the interactive playback of the content.

The customer can use the portable non-volatile solid-state storage device with a compatible portable non-volatile solid-state storage device reader to interactively playback the Digital Entertainment Media Data on the customer's television set, video game system, mobile phone, wireless device, or computer based system.

### CROSS-REFERENCE TO RELATED APPLICATIONS

This is a continuation of U.S. patent application Ser. No. 11/255,238, which was filed Oct. 21, 2005.

### FIELD OF THE INVENTION

This invention relates to the method to store and distribute Digital Entertainment Media Data (DEMD) stored on a portable non-volatile solid-state storage device with a customer selected security identification feature and content management system.

### BACKGROUND OF THE INVENTION

The present invention relates to a method for the distribution of Digital Entertainment Media Data (DEMD) to a customer using a portable non-volatile solid-state storage device in a secure manner. The Digital Entertainment Media Data (DEMD) on the portable non-volatile solid-state storage device will be available in a read-only, permanent or read-write-erase, temporary format. All the Digital Entertainment Media Data will be supplied electronically to the portable non-volatile solid-state storage device from a Digital Entertainment Media Data Database Computer System (DEMDDCS). The Digital Entertainment Media Data (DEMD) can be interactively viewed and interactively controlled on the customer's television set, video game system, mobile phone, wireless device, or computer based system with a compatible portable non-volatile solid-state storage device reader.

At the present time, commercial entertainment media selected by a customer for home viewing or interaction are conventionally provided on cassette tapes in electromagnetic form or on digital disc (DVD/CD) in digital form. The tape or DVD/CD is often rented, for a short period of time or bought from a retail store then taken to the customer's home and played there on a mechanical player electronically connected to the customer's television. In most cases, the rented tape or DVD must be returned to the rental store on the due date or a late penalty fee will be charged.

It is the object of the present invention to provide a system which will replace the need for selecting entertainment media, like movies, (or indeed, other media content such as games, software, electronic books, audio books, documents, educational material and other formats of binary or source code), on conventional mediums, like video cassettes and CD/DVD's, and replace it with the use of a small, portable, re-useable, durable, solid-state memory devices (such as a compact flash card, SD card, MMC, memory stick or the next generation Universal Serial Bus 3 (USB 3) and all former embodiments and previous adaptations) that can be played using a compatible non-mechanical solid-state reader device.

It is further the object of the present invention to provide a new method to store and distribute entertainment media, like movies, (or indeed, other media content such as games, software, electronic books, audio books, documents, educational material and other formats of binary or source code), selected by the customer, from a Digital Entertainment Media Data Database Computer System (DEMDDCS), direct to the customer's portable non-volatile solid-state storage device.

The customer's portable non-volatile solid-state storage device can interactively display the Digital Entertainment Media Data to a television set, video game system, mobile phone, wireless device, or any computer based device using a compatible storage device reader. As flash memory storage devices become less costly, our object of the present invention can utilize the flash memory to provide customers with a more advanced and improved alternative to the conventional videotape and CD/DVD. Both tape and CD/DVD's have a limited life span because of worn tape and surface scratches, respectively. The customers will also have instant access to a large database of Digital Entertainment Media Data, as well as other media content such as games, software, electronic books, audio books, documents, educational material and other formats of binary or source code, in any language, anytime, from virtually any location, in a more convenient, portable and economical way.

### SUMMARY OF THE INVENTION

In accordance with the present invention there is provided a method for distributing Digital Entertainment Media Data (DEMD), to be interactively viewed on a customer's television set, video game system, mobile phone, wireless device, or computer based system. The method comprises the steps of converting audio, video and binary or source code data corresponding to the Digital Entertainment Media Data (DEMD), storing the Digital Entertainment Media Data (DEMD) and supporting data, to a Digital Entertainment Media Data Database Computer System (DEMDDCS), and distributing the Digital Entertainment Media Data (DEMD) to a portable non-volatile solid-state storage device. The customer can select Digital Entertainment Media Data from the Digital Entertainment Media Data Database Computer System and retrieve the Digital Entertainment Media Data (DEMD) and store the data to a portable non-volatile solid-state storage device. The Digital Entertainment Media Data (DEMD) can be written to a portable non-volatile solid-state storage device in a permanent form, in the same manner as commercial CD/DVD's or games are created and packaged by a media vendor or supplier. The customer can then purchase or rent such items as they do a CD/DVD or game. The Digital Entertainment Media Data (DEMD) transmitted to the portable non-volatile solid-state storage device in a permanent or non-permanent form will also contain a content management system to control all playback and interactive aspects of the data. The appended content management system can also act as a security identifier management system.

### BACKGROUND OF INVENTION

### Objects and Advantages

Accordingly, besides the objects and advantages of the portable non-volatile solid-state storage device described in the above background description, several objects and advantages of the present invention are:

(a) A flash memory storage device has no loss of data integrity for over 100 years;
(b) A flash memory storage device has the capacity to be written and read over one million times;
(c) A flash memory storage device has an operating shock rating of 2,000 Gs, which is equivalent to a 10-foot drop;
(d) A flash memory storage device does not require a battery to retain data indefinitely;
(e) A flash memory storage device weighs a half-ounce and is the size of a matchbook or smaller;
(f) A flash memory storage device data is protected by a built-in dynamic defect management and error correction technology;
(g) A flash memory storage device provides low cost storage solution for all capacities;
(h) A USB 3 flash memory storage device will provide a data throughput capacity of 5 Gigabytes per second.
(i) Digital Entertainment Media Data (DEMD) is secure;
(j) Digital Entertainment Media Data (DEMD) can be easily stored to compatible storage devices;
(k) Digital Entertainment Media Data (DEMD) can by transferred across networks or the Internet;
(l) Digital Entertainment Media Data (DEMD) can be converted into various video formats;
(m) Digital Entertainment Media Data (DEMD) can be in a foreign language;
(n) Digital Entertainment Media Data (DEMD) can be compressed to minimized required space;
(o) Digital Entertainment Media Data (DEMD) is compatible with personal playing devices;
(p) A Digital Entertainment Media Data Database Computer System (DEMDDCS) can provide a cost effective method to deliver a Digital Entertainment Media Data to customers, since no physical delivery of the data is necessary;
(q) A Digital Entertainment Media Data Database Computer System (DEMDDCS) can reduce the cost of retail space, needed by a typical retail store, through use of multiple computer terminals connected to the database, therefore lessening the need for large wall display areas;
(r) A Digital Entertainment Media Data Database Computer System (DEMDDCS) can allow a customer to access reviews, viewer recommendations as well as short trailers or samples that can be viewed before renting or purchasing the media;
(s) A Digital Entertainment Media Data Database Computer System (DEMDDCS) can be available to the customer 24 hours per day, 7 days per week, anywhere in the world and in any language;
(t) A Digital Entertainment Media Data Database Computer System (DEMDDCS) can store foreign Digital Entertainment Media Data Files in different formats depending upon which system is required per each geographical location, such as NTSC, PAL and SECAM;
(u) A Digital Entertainment Media Data Database Computer System (DEMDDCS) can be networked together through the use of a Local Area Network (LAN), Wide Area Network (WAN), or high-speed Internet connection to allow for easy transfer of the Digital Entertainment Media Data between systems and customers;
(v) A Digital Entertainment Media Data Player (DEMDP) is small, portable and light;
(w) A Digital Entertainment Media Data Player (DEMDP) is compatible with most flash memory storage devices;
(x) A Digital Entertainment Media Data Player (DEMDP) is upgradeable as newer technologies are developed;
(y) A Digital Entertainment Media Data Player (DEMDP) can be utilized in many areas, such as the automotive and aerospace industry;
(z) A Digital Entertainment Media Data Player (DEMDP) can be implemented into existing portable devices;

Further objects and advantages are to provide a method of media distribution, which can be used easily and conveniently to allow any person with a compatible non-volatile solid-state storage device to use our system to acquire full-length movies, as well as be expandable as other digital file formats become available, such as games, software, documents, e-books, audio books, photographs, music, and educational courses. Still further objects and advantages will become apparent from a consideration of the ensuing description and drawings.

### BRIEF DESCRIPTION OF THE DRAWINGS

These and other objects and advantages of the invention will become apparent upon reading the following detailed description and upon referring to the drawings in which:

FIG. 1 constitutes a flow chart illustrating the manner in which Digital Entertainment Media Data is prepared for storage and stored on a Digital Entertainment Media Database Computer System;

FIG. 2 is a diagram of the method of and apparatus for distributing Digital Entertainment Media Data (DEMD) to a customer to be stored on a portable non-volatile solid-state storage device; and

FIG. 3 is a diagram of the method of and apparatus for viewing the Digital Entertainment Media Data (DEMD) on the customer's television set, video game system, mobile phone, wireless device, or any computer based system, in accordance with the present invention.

While the invention will be described in conjunction with an example method, it will be understood that it is not intended to limit the invention to such a method. On the contrary, it is intended to cover all alternatives, modifications and equivalents as may be included within the spirit and scope of the invention as defined by the appended claims.

### DRAWINGS

### Reference Numerals

| | | | |
|---|---|---|---|
| 2 | Media in CD/DVD format | 4 | Media in Film or Video format |
| 6 | Audio, Video Digitizer | 8 | Binary and Source Code |
| | | | Converter |
| 10 | Media Computer Encoder System | 12 | Digital Entertainment Media Data |
| 14 | DEMD Database Computer | 16 | Remote DEMD Database |
| | System | | Computer System |
| 18 | Kiosk DEMD Database Computer | 20 | Online DEMD Database |
| | System | | Computer System |
| 22 | Interactive Security Identification | 24 | Portable Non-Volatile Solid-State |
| | System | | Storage Device |
| 26 | Portable Non-Volatile Solid-State | 28 | Interactive Security ID System Verifier |
| | Storage Device Reader | | |
| 30 | Digital Entertainment Media Data | | |
| | Output to Display | | |

### DETAILED DESCRIPTION OF THE INVENTION

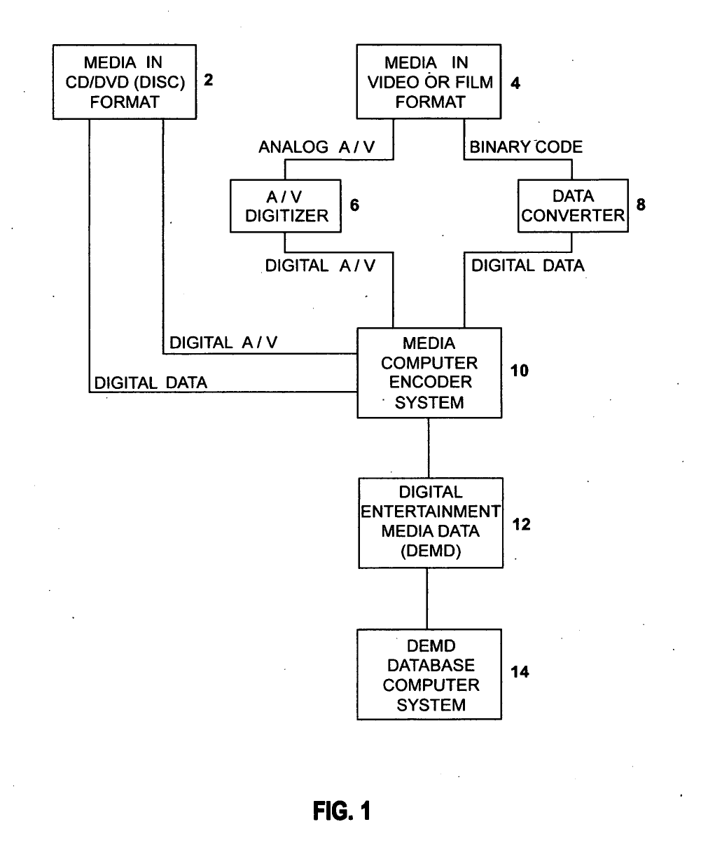

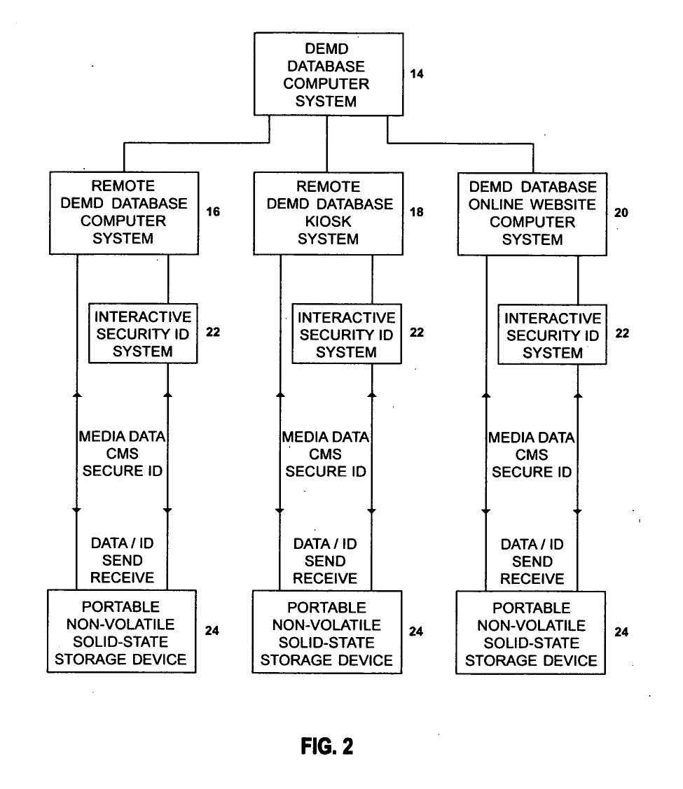

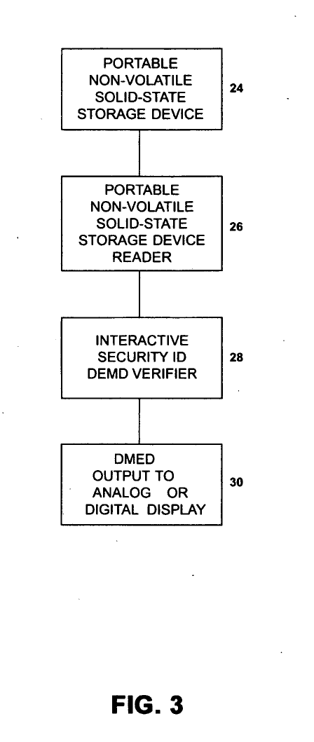

The present invention relates to a method of storing and distributing Digital Entertainment Media Data on a portable non-volatile solid-state storage device. The distribution system consisting of a film, video, DVD, CDROM, an audio, video, binary or source code data, Converter System, a Digital Entertainment Media Data Encoder Computer, and a Digital Entertainment Media Data Database Computer System connected to a LAN, WAN or Internet, in a wired, wireless or a combined network infrastructure, illustrated in more detail in FIG. 1 and FIG. 2. Located at the customer's site is a compatible non-volatile solid-state storage device reader (FIG. 3) facilitating Digital Entertainment Media Data playback interactively transmitted in real-time, electronically or wirelessly connected to the user's television set, or computer based system, such as a personal computer, video game system, mobile phone, handheld personal data assistant, or wireless computer device.

### 1. Audio, Video and Binary or Source Code Data Converter System

Turning to FIG. 1, a medium containing Entertainment Media is received on a digital data disc (2), film or magnetic tape (4) either in conventional analog or digital format. Typically, video enabled media is output in real-time at 25 to 30 frames per second portraying full motion effects with synchronized audio. The analog or binary source code data signals are converted with separate converters (6 and 8 respectively) using a wide array of algorithm schemes to produce an uncompressed digital media data file, which are sequentially input to the Digital Media Computer Compressions System (10).
The Digital Media Encoder Computer System (10) consists of a personal computer system with special encoding hardware or software allowing the system to encode the uncompressed digital media data implementing a combination of codec and data compressions algorithms and store the encoded Digital Entertainment Media Data (12) on a hard disk. The Digital Media Encoder Computer System (10) has the means to append the Digital Media Entertainment Data with a security identification and content management system.

The Digital Media Database Computer System (14) must have the capacity to store the required amount of compressed or uncompressed data for the entire duration of the movie, (or indeed, other media content such as games, software, electronic books, audio books, documents, educational material and other formats of binary or source code) as received from the Digital Media Encoder Computer System (10). Various technologies can be utilized for the Digital Media Database Computer System. The following lists several such technologies as well as their present capacities.

| | |
|---|---|
| DVD-ROM | 9 Gigabytes |
| Hard Disks | 10 Terabytes |
| Solid State Memory | 12 Gigabytes |

These technologies can be grouped individually to ensure sufficient storage capacity or a combination of different technologies can be utilized.

### 2. Digital Entertainment Media Data Database Computer System

Illustrated in FIG. 1 and FIG. 2, the Digital Entertainment Media Data Database Computer System (DMDCS) (14) is the storage apparatus for the Digital Media Entertainment Data (12). It is arranged such that each Digital Media Entertainment Data has a computer generated or user assigned unique identification code that is appended to the Digital Media Entertainment Data (12) when it is initially entered into the Digital Media Database Computer System (14). The Digital Media Database Computer System has the capacity to store (or indeed, communicate with a Security Identification Database Computer System) a customer or media supplier/vendor pre-selected or self-chosen security identifier and verification identification, like a Personal Identification Number (PIN), Personal Identification Alphanumeric Password (PIAP), Personal Keystroke Sequence Password (PKSP), a combination of keystrokes from any device with a keypad including such devices as a cellular or smart phone and a Personal Game Controller Keystroke Sequence Password (PGKSP), such as a combination of keystrokes from a game system controller, that can be selected via an online interactive graphical interface representing the game controller. These customer selected security identifiers can be used in conjunction with any Digital Database Computer Systems.
The Digital Media Entertainment Data (12) is requested by the customer from a Remote Digital Media Database Computer System (16), such as a client computer terminal attached to a networked computer server in a retail outlet location, a Kiosk Digital Media Database Computer System (18), such as a standalone computer terminal system connected to a wired or wireless network in communication with a LAN, WAN or internet or an Online Digital Media Database Computer System (20), online constituting a wired or wireless LAN WAN or internet based network and after verification of the customer, media vendor/suppliers pre-selected or self-chosen security identifier and verification identification, such as a Personal Identification Number (PIN), Personal Identification Alphanumeric Password (PIAP), Personal Keystroke Sequence Password (PKSP), a combination of keystrokes from any device with a keypad including such devices as a cellular or smart phone and a Personal Game Controller Keystroke Sequence Password (PGCKSP), such as a combination of keystrokes from a game system controller, that can be selected via an online interactive graphical interface representing the game controller, a confirmation is given to the user and the Digital Entertainment Media Data is secured and appended with the customer, media vendor/suppliers pre-selected or self-chosen security identifier and verification identification (22), the content management system if required, then transferred from the Digital Entertainment Media Data Database Computer System to the customers, media vendor/suppliers portable non-volatile solid-state storage device (24). The Digital Entertainment Media Data Database Computer System (14) also automatically collects statistics (frequently requested media, time and place of downloads, etc.) and performs all accounting requirements.
Turning to FIG. 3, it is a preferred aspect of the present invention that the customer, media vendor/suppliers portable non-volatile solid-state storage device (24) allows interactive replay on a compatible Portable Non-Volatile Solid-State Storage Device Reader (26) if the Interactive Security ID Verifier (28) verifies the correct security identifier or verification identification, or a combination of both identifiers interactively provided from the customer, media vendor/suppliers, who must input their pre-selected or self-chosen security identifier or verification identification, or a combination of both identifiers, to unlocked the Digital Entertainment Media Data (12) which can then be output to the television set, video game system, mobile phone, wireless device, or computer based system with a compatible portable non-volatile solid-state storage device reader. (30).

Thus it is apparent that there has been provided in accordance with the invention a method and apparatus for distribution of Digital Entertainment Media Data to a customer, media vendor or supplier, on portable non-volatile solid-state storage device, that fully satisfies the objects, aims and advantages set forth above. While the invention has been described in conjunction with a specific methodology thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

What we claim as our invention:

1. A method to convert, store and transmit (simultaneously distribute to an unlimited number of customers and media suppliers/vendors) Digital Entertainment Media Data (DEMD), such as movies, games, software, electronic books, audio books, documents, educational material and other formats of binary or source code, containing an appended customer or media supplier/vendor interactive security identifier feature, interactive content management system, to be stored on a portable non-volatile solid-state storage device, in a permanent or non-permanent state, the method comprising the steps of
(a) Converting or encoding the audio, video, compiled or un-compiled binary source code corresponding to a medium containing the Entertainment Media to a single or plurality of interconnected, executable or non-executable, binary files;
(b) Storing the converted Digital Entertainment Media Data (DEMD) to a local or remote Digital Entertainment Media Data Database Computer System (DEMDDCS), connected to a series of interconnected electronic components, or to a wired or wireless network, such as a Local Area Network (LAN), Wide Area Network (WAN), Internet or Intranet;
(c) Transmitting the converted Digital Entertainment Media Data (DEMD), from the Digital Entertainment Media Data Database Computer System (DEMDDCS), upon receipt of a request from a verified customer or media supplier/vendor, via an interconnection of electronic components, or from a wired or wireless network, (such as a Local Area Network (LAN), Wide Area Network (WAN), Internet or Intranet) appended with a customer or media supplier/vendors pre-selected or self-chosen security identifier or the verification identification, or a combination of both, appended with a generic or device specific content management system, to a portable non-volatile solid-state storage device, in a permanent or non-permanent state;
(d) Interactively enable the playback or access to the Digital Entertainment Media Data (DEMD) from the portable non-volatile solid-state storage device, or a portable non-volatile solid-state storage device reader, interconnected with a series of electronic components, or a wired or wireless network, the device having the means to read, interactively verify the customer or media supplier/vendor pre-selected or self-chosen security identifier or the verification identification, or a combination of both and convert the Digital Entertainment Media Data (DEMD) to an audio, video and binary or source code data signal, or data stream that can be viewed or interactively controlled from the device, connected to a standard analog or digital output display.

2. A method according to claim 1 wherein the preliminary step comprises converting or encoding the audio, video, compiled or un-compiled binary source code corresponding to a medium containing the Digital Entertainment Media Data (DEMD) to a single or plurality of interconnected, executable or non-executable, binary files.

3. A method according to claim 2 wherein the converted Digital Entertainment Media Data (DEMD) can be stored in an array of formats encompassing a plurality of codec algorithms, geographical aspect scan line ratios (like NTSC, PAL, SECAM), a plurality of file formats (such as avi, mpeg, pdf, mp4, mov, ppt, etc), or as a single or combination of available variable arrays, allowing the means of interactive playback, interactive data control and display capabilities in any geographical location.

4. A method according to claim 3 wherein the converted Digital Entertainment Media Data (DEMD) can be stored within an audio, video, binary or source code media wrapper or self contained media processor as a single or plurality of Digital Entertainment Media Data (DEMD) sources, allowing the means of interactive playback, interactive data control and display capabilities in any geographical location,

5. A method according to claim 1 wherein the portable non-volatile solid-state storage device has the capacity to store an individual Digital Entertainment Media Data source, or a plurality of Digital Entertainment Media Data sources such that there exists a content management system available to control the interactive playback and interactive data control playback features.

6. A method according to claim 5 wherein the content management system is connected on a binary source code level, or interconnected with a combination of electronic components and binary code, located within the embodiment of the portable non-volatile solid-state storage device, to the Digital Entertainment Media Data (DEMD).

7. A method according to claim 5 wherein the embodied content management system has the means to categorize, sort, assemble, display an individual or a plurality of data streams, control a plurality of layered data streams, and provide the customer or media vendor/supplier, the ability to control all playback features of the Digital Entertainment Media Data, stored on the portable non-volatile solid-state storage device.

8. A method according to claim 5 wherein the content management system is a self executing compiled data source, an executable complied data source implemented into a microprocessor embodied in the portable non-volatile solid-state storage device, or exists as a combination of both process methods.

9. A method according to claim 8 wherein the content management systems self executing compiled data source, or executable complied data source implemented into a microprocessor, embodied in the portable non-volatile solid-state storage device, or the existence of a combination of both process methods, has the means to communicate with wireless devices, such as smart phones, multimedia players, personal computer based devices or gaming devices that have external connectivity capabilities.

10. A method according to claim 1 wherein the local or remote Digital Entertainment Media Data Database Computer System (DEMDDCS), connected to a series of interconnected electronic components, or to a wired or wireless network, such as a Local Area Network (LAN), Wide Area Network (WAN), Internet or Intranet, has the means to communicate with a customer, media vendor and supplier Security Identifier Database Computer System, containing pre-selected or self-chosen security identifiers, such that the security identifier can be transmitted and embedded into the Digital Entertainment Media Data (DEMD) source, upon completion of a verified request.

11. A method according to claim 10 wherein the Security Identifier Database Computer System storing the customers, media vendors and suppliers pre-selected or self-chosen security identifier or the verification identification, or a combination of both, can consist of any alphanumeric character, sequence of keystrokes on any compatible keyboard, a sequence of keystrokes on a game controller, such as you would find on a Playstation, XBOX or WII game console (or indeed, other game systems, smart phones, portable players, etc) or any such device that can send an electronic signal to a connected device.

12. A method according to claim 11 wherein the customers, media vendors and suppliers pre-selected or self-chosen security identifier or the verification identification, or a combination of both, to be stored on a Security Identifier Database Computer System, secured to the selected Digital Entertainment Media Data (DEMD), then transmitted to a portable non-volatile solid-state storage device, in a permanent or non-permanent state, the method comprising the steps of:
(a) Requesting the customers, media vendors and suppliers to pre-select or self-chose a security identifier and verification identification, that can be entered through an online registration website, keypad at any location with a compatible or authorized terminal, cellular phone or smart phone with alphanumeric or web based capability, game consoles with internet connections or any computer based system that can access the internet.
(b) Securely storing the customers, media vendors and suppliers pre-selected or self-chosen security identifier and verification identification that was entered through an online registration website, keypad at any location with a compatible or authorized terminal, cellular phone or smart phone with alphanumeric or web based capability, game consoles with internet connection or any computer based system that can access the internet.
(c) Securely encrypting the customers, media vendors and suppliers pre-selected or self-chosen security identifier and verification identification, with 128 bit encryption or higher, that was entered through an online registration website, keypad at any location with a compatible or authorized terminal, cellular phone or smart phone with alphanumeric or web based capability, game consoles with internet connection or any computer based system that can access the internet.

13. A method according to claim 11 wherein the customers, media vendors and suppliers selecting a sequence of keystrokes from a game controller, (such as you would find on a Playstation, XBOX or WII game console, or indeed other game systems), as their pre-selected or self-chosen security identifier, can input their keystroke sequence on a graphical interface, displaying and representing their chosen game controller, through an online registration website, authorized terminal location, cellular phone or smart phone with alphanumeric or web based capability, game console with internet connection or any computer based system that can access the internet, such that the input device can send an electronic signal to the Security Identifier Database Computer System.

14. A method according to claim 12 wherein the customer, media vendor and supplier can input a pre-selected or self-chosen security identifier and verification identification, encompassing alphanumeric characters such a Personal Identification Number (PIN), Personal Identification Alphanumeric Password (PIAP), Personal Keystroke Sequence Password (PKSP), a combination of keystrokes from any device with a keypad including such devices as a cellular or smart phone and a Personal Game Controller Keystroke Sequence Password (PGCKSP), such as a combination of keystrokes from a game system controller.

15. A method according to claim 12 wherein the customer, media vendor and supplier can input additional verification identification such as, a credit card number, membership number, drivers license number, social security number, email address or any alphanumeric characters or a minimum number of required game controller keystrokes that are unique to the customer, media vendor and supplier.

16. A method according to claim 1 wherein the step of acquiring the Digital Entertainment Media Data (DEMD), to be transmitted to the portable non-volatile solid-state storage device, in a permanent or non-permanent state, is performed only upon the customer, media vendor or supplier interactively providing the correct pre-selected or self-chosen security identifier or the verification identification, or a combination of both, provided to the Security Identifier System prior to the initial request.

17. A method according to claim 1 wherein the step of enabling interactive playback, interactive control or accessing the Digital Entertainment Media Data (DEMD) is performed only upon the customer, media vendor or supplier interactively providing the correct pre-selected or self-chosen security identifier, verification identification, or a combination of both identifiers, assigned to the Digital Entertainment Media Data (DEMD) or portable non-volatile solid-state storage device during time of transmittal.

18. A method according to claim 5 wherein a content management system, enabling and controlling the playback of a plurality of data streams, such as an entire collection of movie trailers from a film festival, an entire movie trilogy, a television series, or electronic book series, can be stored on a portable non-volatile solid-state storage device. The portable non-volatile solid-state storage device, such as a Universal Serial Bus version 3 (as well as all previous releases and future revisions) providing high capacity throughput, and storage capacity

19. A method according to claim 18 wherein the step of enabling transmittal of a plurality of Digital Entertainment Media Data (or indeed, other media data such as movies, games, software, electronic books, audio books, documents, educational material and other formats of binary or source code) to be stored on a portable non-volatile solid-state storage device, is performed only upon the customer, media vendor or supplier interactively providing the correct pre-selected or self-chosen security identifier or verification identification, or a combination of both identifiers, stored on the Security Identifier Database Computer System.

20. A method according to claim 1 wherein a plurality of Digital Entertainment Media Data (DEMD) can be secured individually or in groups requiring the customer, media vendor or supplier, in both cases, to interactively provide the correct pre-selected or self-chosen security identifier or verification identification, or a combination of both identifiers, to access the pre-determined single or group of data sources, to be provide interactive playback, interactive control, or access to the Digital Entertainment Media Data (DEMD).
